(19) United States
(12) Patent Application Publication
(10) Pub. No.: US 2024/0383448 A1
(43) Pub. Date: Nov. 21, 2024

(54) NOZZLE SYSTEM

(71) Applicants: HYUNDAI MOTOR COMPANY, Seoul (KR); KIA CORPORATION, Seoul (KR); NIFCO KOREA INC., Asan-si (KR); DY AUTO CORPORATION, Asan-si (KR)

(72) Inventors: Kyung Hwan Kim, Seoul (KR); Nak Kyoung Kong, Seongnam-si (KR); Dong Eun Cha, Hwaseong-si (KR); Sang Heon Wang, Hwaseong-si (KR); Jae Hyoung Kim, Asan-si (KR); Jong Wook Lee, Asan-si (KR); Gyu Seon Lee, Asan-si (KR)

(73) Assignees: HYUNDAI MOTOR COMPANY, Seoul (KR); KIA CORPORATION, Seoul (KR); NIFCO KOREA INC., Asan-si (KR); DY AUTO CORPORATION, Asan-si (KR)

(21) Appl. No.: 18/531,415

(22) Filed: Dec. 6, 2023

(30) Foreign Application Priority Data
May 16, 2023 (KR) 10-2023-0063189

(51) Int. Cl. B60S 1/66; B05B 1/14; B05B 1/28

(52) U.S. Cl. CPC B60S 1/66; B05B 1/14; B05B 1/28

(57) ABSTRACT

A nozzle system includes: a nozzle housing configured to allow fluid flowing from a reservoir located in a vehicle body to flow thereinto; a nozzle cover located at an upper end of the nozzle housing and configured to form a flow path for the fluid flowing into the nozzle housing; and at least two or more nozzle chips configured to face a sensor part. Each of the nozzle chips is detachably coupled to a corresponding opening located in the nozzle cover. The nozzle chips includes two or more discharge ports having different spray angles, where the fluid is sprayed to an area of the sensor part at each of the spray angles through each of the discharge ports.

### CROSS-REFERENCE TO RELATED APPLICATION

This application claims, under 35 U.S.C. § 119(a), the benefit of priority from Korean Patent Application No. 10-2023-0063189, filed on May 16, 2023, the entire contents of which are incorporated herein by reference.

### BACKGROUND

### (a) Technical Field

The present disclosure relates to a nozzle system. More particularly, it relates to a nozzle system capable of providing various spray angles of the nozzle system located adjacent to a circular sensor part and providing a drainage environment.

### (b) Background Art

In general, level 3 of autonomous driving requires various functions such as autonomous driving on highways and autonomous parking. To this end, there is increasing demand for a light detection and ranging (LiDAR) sensor having high range resolution.

Such a LiDAR sensor senses the front and rear of a vehicle and serves to detect an object, a structure, and the like.

Generally, when the LiDAR sensor is installed on glass or other structures of a vehicle body, sensing performance of the LiDAR sensor may significantly deteriorate. For this reason, the LiDAR sensor is mounted on the front bumper and exposed to the outside, thereby preventing the above-described detection performance deterioration.

The LiDAR sensor includes a laser transmission part, a laser reception part, and a driving part. A cover is additionally provided to protect the LiDAR sensor from external contaminants.

In other words, since the LiDAR sensor is a sensor configured to detect a distance through a method of transmitting and receiving light, a cover is essentially required to protect the LiDAR sensor. Accordingly, the LiDAR sensor is significantly sensitive to contamination of the cover, and it is necessary to prevent contamination of the LiDAR sensor in order to reliably maintain sensing performance of the LiDAR sensor.

To this end, a sensor cleaning device may be provided to perform a function of removing foreign substances existing in a field of view (FOV) area of the LiDAR sensor and to perform cleaning of the LiDAR sensor. For example, in the sensor cleaning device, when a washer pump of a reservoir operates, fluid in the reservoir is transferred to a washing nozzle through a hose by pressure of the washer pump, and the fluid is sprayed through the nozzle to remove foreign substances and clean the LiDAR sensor.

However, LiDAR sensors vary in size and FOV area depending on a component supplier or LiDAR performance. Accordingly, when the sensor cleaning device is mounted in a vehicle, it is necessary to develop a separate nozzle suitable for the size and FOV area of the LiDAR sensor.

The above information disclosed in this Background section is only for enhancement of understanding of the background of the disclosure, and therefore it may contain information that does not form the prior art that is already known in this country to a person of ordinary skill in the art.

### SUMMARY OF THE DISCLOSURE

The present disclosure has been made in an effort to solve the above-described problems associated with the prior art, and it is an object of the present disclosure to provide a nozzle system capable of providing various spray environments by including a nozzle chip coupled to an opening formed in a nozzle cover.

Another object of the present disclosure is to provide a nozzle system including a nozzle chip having various spray angles.

The objects of the present disclosure are not limited to the above-mentioned objects, and other technical objects not mentioned herein should be clearly understood by those having ordinary skill in the art from the detailed description of the embodiments. Further, the objects of the present disclosure may be realized by means indicated in the claims and a combination thereof.

In one aspect, the present disclosure provides a nozzle system including: a nozzle housing configured to allow fluid flowing from a reservoir located in a vehicle body to flow thereinto; a nozzle cover located at an upper end of the nozzle housing and configured to form a flow path for the fluid flowing into the nozzle housing; and at least two or more nozzle chips configured to face a sensor part, wherein each of the nozzle chips is detachably coupled to a corresponding opening located in the nozzle cover. The nozzle chips includes two or more discharge ports having different spray angles. The fluid is sprayed to an area of the sensor part at each of the spray angles through each of the discharge ports.

In an embodiment, the two or more discharge ports may include a first discharge port configured to spray the fluid to the sensor part, and a second discharge port configured to have a vertical spray angle lower than a vertical spray angle of the first discharge port.

In another embodiment, the first discharge port may be spaced farther apart from the sensor part than the second discharge port.

In still another embodiment, the second discharge port may be located at a front end of the first discharge port, and may include an inclined portion configured to form the vertical spray angle of the first discharge port.

In yet another embodiment, the nozzle system may further include a drainage part disposed on a side surface of each of the at least two or more nozzle chips and fluidly connected to the first discharge port, wherein the second discharge port is located on the side surface.

In still yet another embodiment, a horizontal area of the fluid sprayed through the second discharge port may be wider than a horizontal area of the fluid sprayed through the first discharge port.

In another aspect, the present disclosure provides a nozzle system including: a nozzle housing including an inlet part configured to allow fluid flowing from a reservoir located in a vehicle body to flow therethrough; a nozzle cover located at an upper end of the nozzle housing to cover the upper end and configured to form a flow path of the fluid, wherein the nozzle cover includes openings in an area thereof facing a sensor part; and at least two or more nozzle chips configured to face the sensor part, wherein each of the nozzle chips is detachably coupled to a corresponding one of the openings. Each nozzle chip includes two or more discharge ports having different spray angles, and the fluid is sprayed to an area of the sensor part at each of the spray angles through each of the discharge ports.

In an embodiment, the two or more discharge ports may include a first discharge port configured to spray the fluid to the sensor part, and a second discharge port configured to have a vertical spray angle lower than a vertical spray angle of the first discharge port.

In another embodiment, the first discharge port may be spaced farther apart from the sensor part than the second discharge port.

In still another embodiment, the second discharge port may be located at a front end of the first discharge port, and may include an inclined portion configured to form the vertical spray angle of the first discharge port.

In yet another embodiment, the nozzle system may further include a drainage part disposed on a side surface of each nozzle chip and fluidly connected to the first discharge port, wherein the second discharge port is located on the side surface.

In still yet another embodiment, a horizontal area of the fluid sprayed through the second discharge port may be wider than a horizontal area of the fluid sprayed through the first discharge port.

Other aspects and embodiments of the disclosure are discussed below.

It is understood that the terms “vehicle”, “vehicular”, and other similar terms as used herein are inclusive of motor vehicles in general, such as passenger automobiles including sport utility vehicles (SUV), buses, trucks, various commercial vehicles, watercraft including a variety of boats and ships, aircraft, and the like, and include hybrid vehicles, electric vehicles, plug-in hybrid electric vehicles, hydrogen-powered vehicles, and other alternative fuel vehicles (e.g. fuels derived from resources other than petroleum). As referred to herein, a hybrid vehicle is a vehicle that has two or more sources of power, for example, vehicles powered by both gasoline and electricity.

The above and other features of the disclosure are discussed below.

### BRIEF DESCRIPTION OF THE DRAWINGS

The above and other features of the present disclosure are described in detail below with reference to certain embodiments thereof illustrated in the accompanying drawings which are given hereinbelow by way of illustration only, and thus are not limitative of the present disclosure, and wherein:

FIG. 1 is a perspective view of a nozzle system according to an embodiment of the present disclosure;

FIG. 2 is a coupling diagram of the nozzle system according to an embodiment of the present disclosure;

FIG. 3 is a cross-sectional side view of the nozzle system according to an embodiment of the present disclosure;

FIG. 4A is a perspective view of a nozzle chip of the nozzle system according to an embodiment of the present disclosure;

FIG. 4B is a front view of the nozzle chip of the nozzle system according to an embodiment of the present disclosure; and

FIG. 4C is a diagram showing a fluid spray angle of the nozzle chip of the nozzle system according to an embodiment of the present disclosure.

It should be understood that the appended drawings are not necessarily to scale, presenting a somewhat simplified representation of various features illustrative of the basic principles of the disclosure. The specific design features of the present disclosure as disclosed herein, including, for example, specific dimensions, orientations, locations, and shapes will be determined in part by the particular intended application and use environment.

In the figures, reference numbers refer to the same or equivalent parts of the present disclosure throughout the several figures of the drawing.

### DETAILED DESCRIPTION

Hereinafter, reference is made in detail to various embodiments of the present disclosure, examples of which are illustrated in the accompanying drawings and described below. While the disclosure is described in conjunction with certain embodiments, it should be understood that present description is not intended to limit the disclosure to the embodiments disclosed herein. On the contrary, the disclosure is intended to cover not only the disclosed embodiments, but also various alternatives, modifications, equivalents, and other embodiments, which may be included within the spirit and scope of the disclosure as defined by the appended claims.

In addition, terms such as “part”, “port”, and “system” described in the specification mean a unit that perform at least one function or operation, and the function or operation may be implemented in hardware or software or a combination of hardware and software.

Additionally, the terms in the specification are used merely to describe embodiments, and are not intended to limit the present disclosure. In this specification, an expression in a singular form also includes a plural form, unless clearly specified otherwise in context.

In the present disclosure, terms such as “first” and/or “second” may be used to describe various components, but the components are not limited by these terms. These terms are used only for the purpose of distinguishing one component from other components. For example, a first component may be referred to as a second component, and similarly, a second component may also be referred to as a first component without departing from the scope of rights according to the concept of the present disclosure.

In addition, as a configuration direction in the present disclosure, the vertical direction means the height direction of a sensor part 20, and the horizontal direction means the width direction based on the sensor part 20. In one example, the vertical direction and the horizontal direction are perpendicular to each other, the same are not limited to the shape of the sensor part 20.

When a component, device, element, or the like of the present disclosure is described as having a purpose or performing an operation, function, or the like, the component, device, or element should be considered herein as being “configured to” meet that purpose or to perform that operation or function.

Hereinafter, embodiments are described in detail with reference to the accompanying drawings. In the following description with reference to the accompanying drawings, the same reference numerals represent the same or corresponding components throughout the specification, and redundant descriptions thereof have been omitted.

In the present disclosure, the sensor part 20 is described as a target of a LiDAR sensor, and a nozzle system 10 configured to remove foreign substances existing in a field of view (FOV) area of the LiDAR sensor is disclosed as an embodiment. However, the sensor part 20 is not limited to the LiDAR sensor.

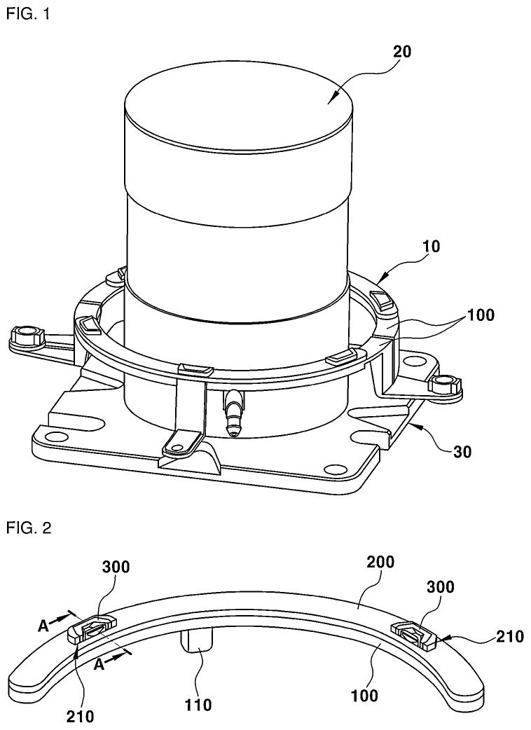

FIG. 1 is a perspective view of a nozzle system according to an embodiment of the present disclosure.

As shown in the drawing, the nozzle system 10 includes the sensor part 20 protruding outwards from a vehicle body 30. According to an embodiment of the present disclosure, the nozzle system 10 includes the sensor part 20 serving as a LiDAR sensor and a nozzle housing 100 configured to surround the LiDAR sensor.

According to an embodiment of the present disclosure, the LiDAR sensor emits laser light in a preset direction and detects the same so as to perform a function of determining a distance between an ego vehicle and a surrounding object and a shape of the surrounding object. The LiDAR sensor applied to a vehicle generally serves to scan terrain corresponding to a surrounding region of interest and an obstacle and to collect, in real time, surface information of the terrain and the obstacle while the vehicle is travelling.

This LiDAR has a principle similar to that of RADAR, but in the case of RADAR, electromagnetic waves are emitted to the outside and re-received electromagnetic waves are used to check a distance and a direction. LiDAR is different from RADAR in that LiDAR emits laser light, and LiDAR uses laser light having a short wavelength, thereby making it possible not only to achieve high precision and resolution but also to create a dimensional image depending on an object.

When the sensor part 20 disposed to protrude toward the outside of a vehicle, such as a LiDAR sensor, is applied to the vehicle to detect an external object, the same is contaminated by foreign substances. In this case, foreign substances on the sensor part 20 are removed by spraying fluid on the sensor part 20.

The nozzle system 10 configured to surround the sensor part 20 includes a nozzle housing 100 fluidly connected to a reservoir (not shown) in which fluid is stored in the vehicle body 30. The nozzle system 10 also includes a nozzle cover 200 configured to cover the upper surface of the nozzle housing 100. The nozzle housing 100 may include at least one inlet part 110 configured to allow fluid flowing from the reservoir to flow thereinto. Further, the nozzle housing 100 is formed in an annular shape, and the same has a tubular cross-section with a hollow inner portion and an open top portion. When the nozzle cover 200 and the nozzle housing 100 are coupled to each other, the nozzle housing 100 and the nozzle cover 200 are formed in a conduit shape, thereby allowing fluid to flow through the conduit shape.

Furthermore, the nozzle housing 100 and the nozzle cover 200 are configured to have an arc shape while being adjacent to the sensor part 20. The nozzle housing 100 and the nozzle cover 200 can be formed in a single shape or divided into two or more parts so as to surround the sensor part 20.

The nozzle cover 200 is configured to cover the open upper surface of the nozzle housing 100 and includes at least one opening 210 in the nozzle cover 200. The opening 210 may be formed at a position where the nozzle chip 300 is coupled to the opening 210. In an embodiment of the present disclosure, four openings 210 may be disposed to have a 90-degree interval of the nozzle cover 200.

The nozzle chip 300 may be attachable to and detachable from the opening 210 of the nozzle cover 200. In one example, the nozzle chip 300 is selectively replaceable in response to physical properties of fluid and external temperature. As such, the nozzle chip 300 disclosed in the present disclosure is capable of being selectively applied to the nozzle cover 200 depending on physical properties of fluid used and outside air information.

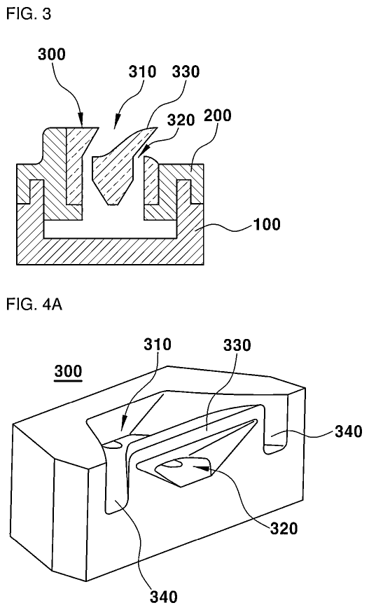

FIG. 2 shows the nozzle system 10 according to an embodiment of the present disclosure, and FIG. 3 shows the nozzle chip 300 located in the opening 210 of the nozzle cover 200.

The nozzle system 10 includes two nozzle housings 100 based on the sensor part 20, and each nozzle housing 100 is configured to allow fluid flowing from the reservoir to flow thereinto through respective inlet parts 110 on each nozzle housing 100. Furthermore, the nozzle system 10 includes the nozzle cover 200 located corresponding to each of the two nozzle housings 100 separated from each other. FIG. 1 shows the set of two nozzle housings 100 and nozzle covers 200 surrounding the sensor part 20, while FIG. 2 shows a more detailed view of one nozzle housing 100 and corresponding nozzle cover 200.

Each nozzle cover 200 is configured to correspond to each of the two nozzle housings 100 and is coupled to the nozzle housing 100 to cover the upper surface of the nozzle housing 100. Furthermore, a flow path is formed to allow fluid to flow through a space between the nozzle housing 100 and the nozzle cover 200.

In the illustrated embodiments of the present disclosure, one nozzle cover 200 is configured to include two openings 210. Accordingly, four openings 210 are disposed in two nozzle covers 200 facing each other. The nozzle chip 300 is located in the opening 210 of the nozzle cover 200. As disclosed below, the nozzle chip 300 includes at least two different spray angles in the vertical direction. Moreover, areas to be sprayed may be different from each other in the horizontal direction.

FIG. 3 shows a cross-section taken along line A-A in FIG. 2, and shows the nozzle cover 200 configured to cover the upper surface of the nozzle housing 100. In this example, a part of the nozzle cover 200 is inserted into the opening 210.

The nozzle cover 200 has one surface facing the sensor part 20. In this example, the one surface of the nozzle cover 200 has a vertical height lower than a vertical height of the other surface thereof located to be spaced apart from the sensor part 20 based on the opening 210.

The nozzle chip 300 inserted into and located in the nozzle cover 200 includes a first discharge port 310 and a second discharge port 320. In this example, the first discharge port 310 is disposed to be spaced apart from the sensor part 20, and the second discharge port 320 is disposed adjacent to the sensor part 20 compared to the location of the first discharge port 310. In other words, the first discharge port 310 is spaced further away from the sensor part 20 than the second discharge port 320. Fluid sprayed through the first discharge port 310 is configured to have a vertical spray angle higher than a vertical spray angle of fluid sprayed through the second discharge port 320. In this example, the fluid discharged from the first discharge port 310 is sprayed along an inclined portion 330 located at the upper end of the second discharge port 320. Accordingly, the fluid sprayed through the second discharge port 320 is configured to have a vertical spray angle lower than that of the fluid sprayed through the first discharge port 310.

Additionally, as shown in the drawings, each of the first discharge port 310 and the second discharge port 320 is configured to have a height equal to or lower than a height of the one end of the nozzle cover 200, as shown from the side view of FIG. 3.

In other words, since each of the first discharge port 310 and the second discharge port 320 is configured to have a height equal to or lower than a height of one end of the nozzle cover 200, the first discharge port 310 and the second discharge port 320 do not protrude outwards from the nozzle cover 200, thereby preventing the first discharge port 310 and the second discharge port 320 from being damaged. In addition, after spraying fluid is stopped, washer fluid in the first discharge port 310 and the second discharge port 320 is drained, thereby preventing the first discharge port 310 and the second discharge port 320 from being clogged.

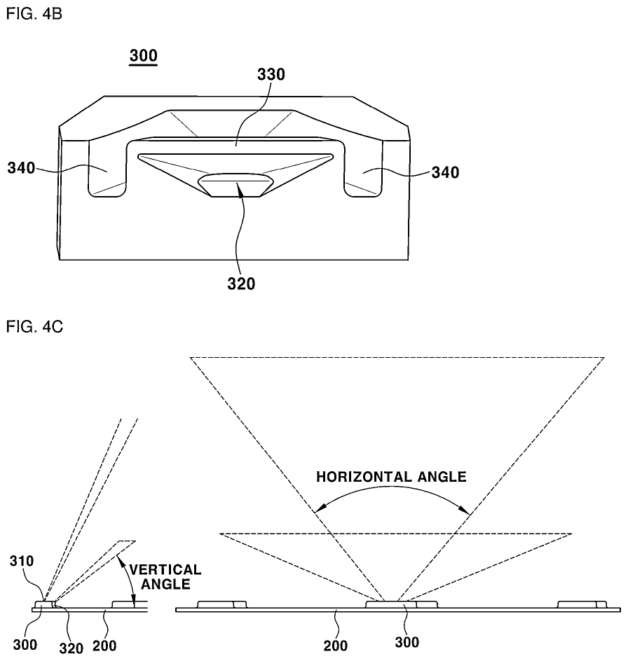

FIGS. 4A and 4B show a perspective view and a front view of the nozzle chip 300, respectively, and FIG. 4C shows a vertical spray angle of fluid sprayed through each of the first discharge port 310 and the second discharge port 320 and a horizontal spray width thereof.

As shown in FIG. 4A, the nozzle chip 300 has the first discharge port 310 and the second discharge port 320 respectively disposed in predetermined locations thereof. The first discharge port 310 is spaced farther apart from the sensor part 20 than the second discharge port 320, and the second discharge port 320 is located closer to the sensor part 20 than the first discharge port 310.

The second discharge port 320 is located adjacent to the sensor part 20 at the front end of the first discharge port 310. The inclined portion 330 configured to form the spray angle of the first discharge port 310 is formed at the rear end of the second discharge port 320. Accordingly, the second discharge port 320 is configured to have a vertical spray angle lower than a vertical spray angle of the first discharge port 310.

As shown in FIG. 4B, when looking at the front view of the nozzle chip 300, the inclined portion 330 is located at the rear end of the second discharge port 320 while being adjacent to the first discharge port 310. Further, the inclined portion 330 is formed to increase in height in the direction adjacent to the sensor part 20 so as to form the spray angle of the first discharge port 310.

Furthermore, the nozzle chip 300 includes a drainage part 340 located along a side of a spray area of the first discharge port 310 and formed along at least one side surface of the opposite side surfaces of the second discharge port 320. When a remaining fluid among the fluids sprayed through the first discharge port 310 is accumulated in the nozzle chip 300, the drainage part 340 may be formed to allow the remaining fluid to be discharged from the spray area of the first discharge port 310. In one example, the drainage part 340 may be formed to gradually decrease in height as a distance between the drainage part 340 and the spray area of the first discharge port 310 increases.

In other words, fluid sprayed from the first discharge port 310 through the upper surface of the nozzle cover 200 is configured to have a spray angle in the inclination direction of the inclined portion 330 formed to protrude from the rear end of the second discharge port 320. Further, after spraying is completed, fluid remaining in the spray area of the first discharge port 310 is discharged through the drainage part 340 formed to be inclined downwards on the opposite sides of the second discharge port 320. Therefore, the vertical spray angle of the first discharge port 310 is formed by the inclination angle of the inclined portion 330, and the remaining fluid is drained from a discharge area of the first discharge port 310 by the drainage part 340.

Additionally, the first discharge port 310 may include a first recessed portion to form a spray area of the sensor part 20 in the horizontal direction. In addition, the second discharge port 320 may include a second recessed portion to form a spray area thereof in the horizontal direction.

The first recessed portion forming the spray area of the first discharge port 310 is formed to be wide in the horizontal direction along an area adjacent to the inclined portion 330 at a location spaced apart from the sensor part 20. Moreover, the second recessed portion is located so as to have a wider cross section in the horizontal direction as the same approaches the sensor part 20 from the spray area of the second discharge port 320.

The width of the horizontal spray area of the first discharge port 310 and the width of the horizontal spray area of the second discharge port 320 are respectively set corresponding to the shapes of the first recessed portion and the second recessed portion. As shown in FIG. 4C, in an embodiment of the present disclosure, the horizontal spray area in which fluid is sprayed to the sensor part 20 through the first discharge port 310 is smaller than the horizontal spray area in which fluid is sprayed to the sensor part 20 through the second discharge port 320.

As described above, the present disclosure provides the nozzle system 10 including a plurality of nozzle chips 300 respectively inserted into and located in the plurality of openings 210 located in the nozzle cover 200, and a plurality of discharge ports 310 and 320 located in the nozzle chip 300 and configured to form different vertical and horizontal spray angles with respect to the sensor part 20. Therefore, the present disclosure provides a technique in which various nozzle chips 300 are provided in one nozzle system 10 so as to clean various types of sensor parts 20.

As is apparent from the above description, the present disclosure may obtain the following effects by a combination of the above-described configurations and a usage relationship therebetween.

The present disclosure has an effect of providing a nozzle system capable of setting horizontal and/or vertical spray angles corresponding to the shape of a nozzle chip. Accordingly, the nozzle system may be applied in various sensor part environments.

In addition, the present disclosure has an effect of providing a nozzle system configured to allow one nozzle chip to have a plurality of discharge ports having different spray angles, thereby making it possible to clean sensor parts disposed at different locations.

The above detailed description is illustrative of the present disclosure. Furthermore, the above description is intended to describe embodiments of the present disclosure, and the present disclosure may be used in various other combinations, modifications, and environments. In other words, changes or modifications are possible within the scope of the concept of the disclosure disclosed in this specification, within the scope equivalent to the disclosed contents, and/or within the scope of ordinary skill or knowledge in the art. The above embodiments describe the best mode to implement the technical idea of the present disclosure, and various changes required in specific application fields and uses of the present disclosure are also possible. Therefore, the detailed description of the disclosure is not intended to limit the disclosure to the disclosed embodiments. Further, the appended claims should be construed as covering other embodiments as well.

What is claimed is:

1. A nozzle system comprising:
a nozzle housing having fluid flowing thereinto;
a nozzle cover located at an upper end of the nozzle housing and configured to form a flow path for the fluid flowing into the nozzle housing; and
at least two or more nozzle chips configured to face a sensor part, wherein each of the at least two or more nozzle chips is detachably coupled to a corresponding opening located in the nozzle cover,
wherein the at least two or more nozzle chips comprise two or more discharge ports having different spray angles, wherein the fluid is sprayed to an area of the sensor part at each of the spray angles through each of the discharge ports.

2. The nozzle system of claim 1, wherein the two or more discharge ports comprise:
a first discharge port configured to spray the fluid to the sensor part; and
a second discharge port configured to have a vertical spray angle lower than a vertical spray angle of the first discharge port.

3. The nozzle system of claim 2, wherein the first discharge port is spaced farther apart from the sensor part than the second discharge port.

4. The nozzle system of claim 2, wherein the second discharge port is located at a front end of the first discharge port, and comprises an inclined portion configured to form the vertical spray angle of the first discharge port.

5. The nozzle system of claim 2, further comprising a drainage part disposed along a side of a spray area of, and fluidly connected to, the first discharge port, wherein the drainage part is disposed along at least one side surface of opposite side surfaces of the second discharge port.

6. The nozzle system of claim 2, wherein a horizontal area of the fluid sprayed through the second discharge port is wider than a horizontal area of the fluid sprayed through the first discharge port.

7. The nozzle system of claim 2, wherein each of the first discharge port and the second discharge port is configured to have a height equal to or lower than a height of an one end of the nozzle cover.

8. The nozzle system of claim 1, wherein each of the nozzle housing and the nozzle cover is configured to have an arc shape.

9. A nozzle system comprising:
a nozzle housing comprising an inlet part configured to allow fluid to flow therethrough;
a nozzle cover located at an upper end of the nozzle housing to cover the upper end and configured to form a flow path of the fluid, wherein the nozzle cover comprises openings in an area thereof facing a sensor part; and
at least two or more nozzle chips configured to face the sensor part, wherein each of the at least two or more nozzle chips is detachably coupled to a corresponding one of the openings,
wherein each of the at least two or more nozzle chips comprise two or more discharge ports having different spray angles, wherein the fluid is sprayed to an area of the sensor part at each of the spray angles through each of the discharge ports.

10. The nozzle system of claim 9, wherein the two or more discharge ports comprise:
a first discharge port configured to spray the fluid to the sensor part; and
a second discharge port configured to have a vertical spray angle lower than a vertical spray angle of the first discharge port.

11. The nozzle system of claim 10, wherein the first discharge port is spaced farther apart from the sensor part than the second discharge port.

12. The nozzle system of claim 10, wherein the second discharge port is located at a front end of the first discharge port, and comprises an inclined portion configured to form the vertical spray angle of the first discharge port.

13. The nozzle system of claim 10, further comprising a drainage part disposed along a side of a spray area of, and fluidly connected to, the first discharge port, wherein the drainage part is disposed along at least one side surface of opposite side surfaces of the second discharge port.

14. The nozzle system of claim 10, wherein a horizontal area of the fluid sprayed through the second discharge port is wider than a horizontal area of the fluid sprayed through the first discharge port.

15. The nozzle system of claim 10, wherein each of the first discharge port and the second discharge port is configured to have a height equal to or lower than a height of an one end of the nozzle cover.

16. The nozzle system of claim 9, wherein each of the nozzle housing and the nozzle cover is configured to have an arc shape.
